(19) United States
(12) Patent Application Publication
(10) Pub. No.: US 2026/0212170 A1
(43) Pub. Date: Jul. 23, 2026

(54) DUAL-CONSTRAINED NEURAL NETWORK COMPRESSION WITH DYNAMIC WEIGHT RESTORATION

(71) Applicant: Microsoft Technology Licensing, LLC, Redmond, WA (US)

(72) Inventor: Aditya Vasanth CHALLAPALLY, Redmond, CA (US)

(21) Appl. No.: 19/032,861

(22) Filed: Jan. 21, 2025

(51) Int. Cl. G06N 3/0495; G06N 3/082

(52) U.S. Cl. CPC G06N 3/0495; G06N 3/082

(57) ABSTRACT

Techniques for dynamically compressing neural network models enable efficient deployment on resource-constrained devices. A compression manager monitors device metrics and application requirements to determine when compression is needed. Model-specific compression instructions guide sequential operations including quantization, layer fusion, pruning, and aggressive pruning, with each operation's parameters specified per layer. Compression metadata preserves information needed for potential restoration. When resources become constrained, the system progressively applies compression while maintaining critical model capabilities. As resources become available, compressed components can be selectively restored using stored metadata. The compression level adapts automatically based on real-time conditions, optimizing the balance between model size and performance.

### TECHNICAL FIELD

The present disclosure relates generally to neural network compression systems, and more particularly to methods for dynamic compression and restoration of neural networks based on real-time device and application constraints. Specifically, the disclosure describes techniques for implementing dual-constrained neural network compression that simultaneously optimizes for both device-level metrics (e.g., memory availability, CPU/GPU usage, power status) and application requirements (accuracy, latency targets). The technical field encompasses machine learning, artificial intelligence, and specifically the development of hierarchical compression decision-making processes that prioritize reversible compression methods while maintaining model accuracy and performance under varying computational and memory constraints.

### BACKGROUND

Neural network compression refers to a set of techniques designed to reduce the size, computational complexity, and energy consumption of neural networks, enabling their deployment on resource-constrained edge devices such as mobile phones, IoT (Internet of Things) devices, wearable computing device, and other Internet-connected hardware. Compression is critical for maintaining the performance of neural networks while meeting the hardware and power limitations of these devices, which often require real-time processing with minimal latency. Common techniques for neural network compression include pruning, which removes redundant or non-contributory parameters; quantization, which reduces the numerical precision of weights and activations; and knowledge distillation, where a smaller model is trained to emulate the behavior of a larger model. Other methods, such as low-rank approximations, sparsity-based optimizations, and lightweight architectures, further enhance efficiency. By employing these techniques, neural networks can deliver robust performance within the constraints of edge computing environments.

### BRIEF DESCRIPTION OF THE DRAWINGS

Embodiments of the present invention are illustrated by way of example and not limitation in the figures of the accompanying drawings, in which:

FIG. 1 is a block diagram illustrating a neural network model architecture having input, hidden, and output layers connected by synapses, where different layers and neurons have varying impacts on model accuracy, according to one embodiment.

FIG. 2 is a block diagram illustrating model training and analysis components that generate model-specific compression instructions based on device specifications and training data, consistent with some embodiments.

FIG. 3 is a block diagram illustrating a target device architecture including processor, memory, and storage components for executing dynamic compression techniques, according to one embodiment.

FIG. 4 is a table illustrating progressive compression stages with corresponding compression levels achieved through sequential application of compression operations, consistent with some embodiments.

FIG. 5 illustrates quantization compression showing conversion of neural network weights from higher precision to lower precision formats while preserving precision differences, according to one embodiment.

FIG. 6 illustrates layer fusion compression showing combination of consecutive neural network layers while maintaining transformation coefficients, consistent with some embodiments.

FIG. 7 illustrates structured pruning compression showing selective removal of less important neural network connections while preserving pruning masks, according to one embodiment.

FIG. 8 illustrates aggressive pruning compression showing elimination of entire filters, channels and layers while maintaining configuration data, consistent with some embodiments.

FIG. 9 is a block diagram illustrating a software architecture that may be installed on a device to implement the compression techniques, according to one embodiment.

FIG. 10 is a block diagram illustrating components of a computing device suitable for executing the compression techniques, consistent with some embodiments.

### DETAILED DESCRIPTION

Described herein are systems and methods for dual-constrained neural network compression with dynamic weight restoration based on device and application requirements. The system implements a sophisticated compression approach that ranks neural network weights by their performance impact and organizes them into priority tiers, while preserving less important weights in an efficient encoded format for quick retrieval rather than permanent removal. Through active monitoring of both device resources (e.g., RAM, CPU usage, battery status) and application needs (accuracy requirements, response time), the system optimizes compression levels dynamically, temporarily removing lower-priority weights under resource constraints and strategically restoring previously stored weights when resources become available. A multi-level compression pipeline implements combined compression techniques including quantization, pruning, and architecture optimization, with compression decisions weighted according to current deployment conditions. In the following description, for purposes of explanation, numerous specific details are set forth regarding compression workflows, weight storage mechanisms, and restoration processes to provide a thorough understanding of the various aspects of different embodiments of the present invention. It will be evident, however, to one skilled in the art that the present invention may be practiced without all of these specific details.

Neural networks have become increasingly important for edge computing and mobile applications, requiring deployment across a wide range of devices with varying computational resources and capabilities. As these networks grow in complexity and size, the need to compress them for efficient deployment on resource-constrained devices has become critical. Edge devices face particular challenges due to their limited memory, processing power, and energy constraints, making it essential to reduce the memory footprint and computational overhead of neural networks while maintaining their performance.

Conventional approaches to neural network compression suffer from significant technical limitations that impact their effectiveness in real-world deployments. Current systems typically use fixed compression or focus solely on device limitations, resulting in either unnecessary performance degradation or inefficient resource utilization. For example, when a mobile device transitions from battery power to wall power or gains additional available RAM, existing compression systems cannot dynamically expand to utilize these newly available resources. Similarly, when a model is executing on a computer, current systems lack the capability to adaptively adjust their weight configurations and associated memory usage based on available RAM and CPU resources. These technical constraints create a rigid compression framework that cannot effectively balance both device constraints (such as available memory and power) and application requirements (such as accuracy thresholds) simultaneously. Furthermore, conventional systems permanently discard pruned weights during compression, making it impossible to restore model capacity when additional resources become available without requiring a complete model reload, which introduces significant system overhead and potential service interruptions.

To address the aforementioned technical challenges, techniques for the dynamic compression and decompression of a neural network are set forth herein. Consistent with some embodiments, techniques are provided for dynamic compression and expansion of neural network models based on real-time device constraints and application requirements. A companion instruction file accompanies each model deployed to a target device, where the instructions include pre-computed compression parameters that specify both how each layer can be compressed through various operations and the sequence in which operations should be performed to achieve target compression levels while maintaining model performance.

When device resources become constrained, the system progressively applies compression operations according to the model-specific instructions. Rather than permanently removing model components, the system preserves compressed information as metadata stored in long-term device storage, enabling rapid restoration when resources become available. The compression operations include quantization of weights, fusion of compatible layers, structured pruning of less important weights, and selective elimination of filters and channels.

A resource monitoring system tracks device-level metrics and application requirements through a weighted decision framework. When conditions change, such as battery levels dropping or applications requiring higher accuracy, the system automatically adjusts compression levels by balancing different types of constraints. Performance tracking enables automatic compression adjustment—if applications consistently need higher accuracy, the system gradually restores weights while monitoring resources, creating self-optimizing behavior under varying conditions.

The system implements specific thresholds and decision criteria for compression operations based on comprehensive performance analysis. For device-level metrics, compression is triggered when: available RAM drops below 85% of total capacity, CPU utilization exceeds 15% sustained over 30 seconds, or battery level falls below 20%. For application requirements, compression decisions consider: accuracy thresholds (minimum 90% of baseline model accuracy), latency targets (maximum 100 ms inference time), and resource quotas (maximum 75% of allocated memory). These thresholds are dynamically adjusted based on priority levels, with critical applications maintaining higher thresholds (95% accuracy, 50 ms latency) compared to background tasks (85% accuracy, 200 ms latency).

The techniques implement a hierarchical constraint structure where requirements can combine and inherit. Device memory constraints influence application performance targets, and when constraints conflict, relationship scores between requirements determine compression levels. This approach enables true bidirectional compression adaptation while preserving removed weights for restoration and simultaneously optimizing for both device and application constraints.

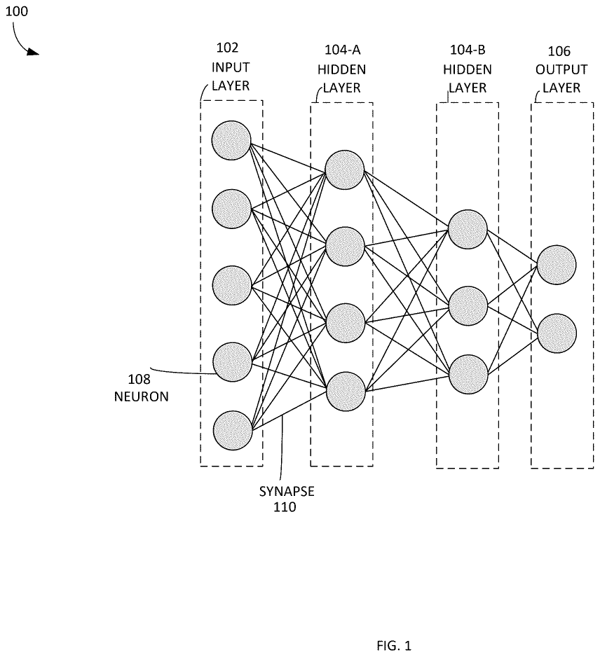

FIG. 1 illustrates a neural network model architecture 100 that forms the basis for the dynamic compression techniques described herein. The model includes an input layer 102, multiple hidden layers 104-A, 104-B, and an output layer 106, with individual neurons (or, nodes) 108 at each layer interconnected by synapses 110 (or, weights). This architecture demonstrates how different layers, neurons and synapses, have varying impacts on the model's overall accuracy and performance, with earlier layers typically having greater influence than later layers.

The layered structure enables the model-specific compression instructions to target compression operations at different granularities. For example, neurons in earlier layers 104-A typically have greater influence on model accuracy than those in later layers 104-B, which informs the compression parameters specified in the instruction file. This varying importance is leveraged by the compression system to make intelligent decisions about which components to compress and in what order.

The synaptic connections 110 between neurons represent weights that can be quantized, pruned, or restored according to the model-specific compression instructions. Consistent with embodiments of the invention, a target device preserves these weights in compressed form rather than discarding them, enabling dynamic restoration when resources permit. The instruction file contains pre-computed parameters that specify exactly how each layer's weights should be compressed while maintaining critical pathways through the network.

This architectural representation underlies the ability to perform targeted compression operations while preserving model accuracy. By analyzing the impact of individual neurons and layers during training, the system generates compression instructions that maintain the most important neural pathways while allowing for dynamic compression and decompression based on available resources.

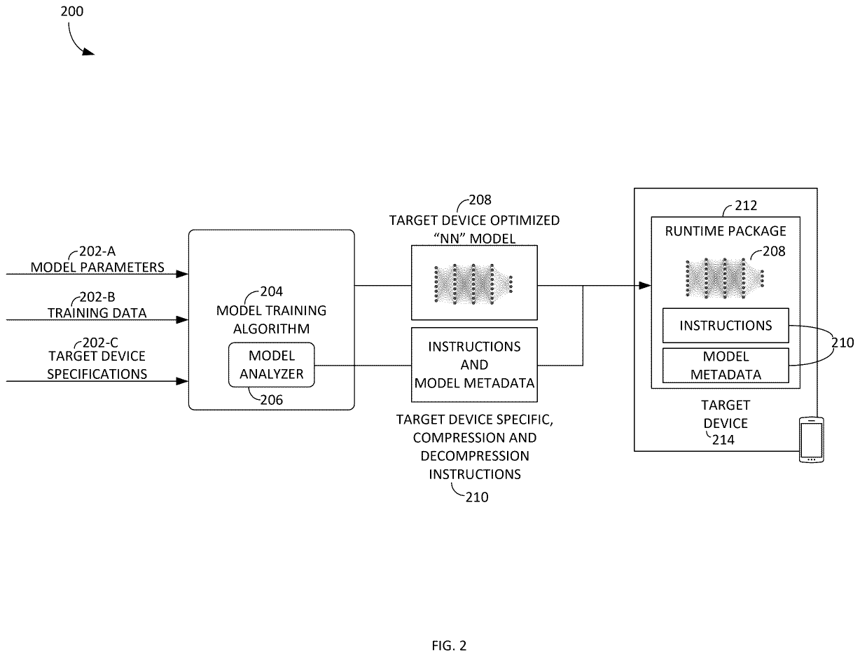

FIG. 2 illustrates a model training and analysis system 200 that generates model-specific compression instructions 210 through a sophisticated training and analysis pipeline. The system receives three primary inputs: model parameters 202-A defining the neural network architecture, training data 202-B for optimizing the model, and target device specifications 202-C that define resource constraints and performance requirements for deployment.

Consistent with some embodiments, the model training algorithm 204 works in conjunction with a model analyzer 206 to evaluate individual model components and generate optimized compression instructions. The model analyzer 210 implements a weight prioritization approach that ranks neural network weights based on their performance impact during training. As part of the model analyzer 210, an importance tracker (not shown) analyzes and tags weights, neurons, and layers, calculating importance scores based on activation patterns during inference, gradient magnitudes during backpropagation, and layer position within the network architecture. Earlier layers typically receive higher importance scores due to their greater influence on model accuracy.

Also as part of the model analyzer 210, a prioritization system (not shown) organizes weights into hierarchical tiers based on computed importance scores. Critical weights essential for accuracy are placed in higher tiers, while less impactful weights are assigned to lower tiers. This organization enables intelligent compression decisions-when resource constraints trigger compression, the system compresses lower-tier weights while preserving crucial higher-tier weights. The system evaluates model behavior across the full training dataset to identify stable compression opportunities, marking weights and layers that consistently show low importance scores as candidates for more aggressive compression.

The importance scoring algorithm implements a multi-factor analysis for each network component. Neuron importance scores are calculated using the formula: I=α*|G|+β*A+γ*C, where |G| represents the average gradient magnitude during training, A represents activation frequency during inference, C represents connectivity degree, and α, β, γ are weighting coefficients optimized during training. The specific values for these coefficients are determined through sensitivity analysis on the training dataset. For example, a typical configuration might use α=0.5, β=0.3, and γ=0.2, reflecting the relative importance of gradient information over activation patterns and connectivity.

Weight ranking methodology employs a hierarchical scoring system. Weights are first categorized into tiers based on their absolute magnitude and then further ranked within each tier based on their impact on model accuracy. The system maintains specific thresholds for each compression stage: weights with importance scores below the 20th percentile are candidates for initial pruning, while scores below the 10th percentile trigger aggressive pruning consideration. These thresholds are adjusted based on observed performance impact during validation testing.

The system implements a validation framework during training to verify compression instruction effectiveness. It performs trial compressions using candidate parameters and measures accuracy impact across different compression levels. This validation ensures the instructions will maintain performance within acceptable thresholds when deployed to target devices with varying resource constraints.

The training phase outputs both an optimized neural network model (208) and corresponding compression metadata 210 containing layer-specific compression parameters, importance scores, and transformation coefficients needed for operations like layer fusion. These outputs are packaged together into a runtime package 212 that enables the target device 214 to perform rapid compression operations while maintaining critical model capabilities identified during training. The instruction file contains specific parameters for each compression operation, including quantization levels, fusion mappings, and pruning thresholds, while the metadata preserves information needed for component restoration.

During runtime on the target device, the weight restoration process leverages the tiered structure to optimize performance recovery when resources become available. A priority queue manages restoration order, with higher-tier weights restored first to maximize performance improvement per unit of restored memory. This approach is enhanced by predictive loading mechanisms that preprocess restoration data for high-priority weights in the background, enabling smooth transitions between compression states while maintaining critical model capabilities.

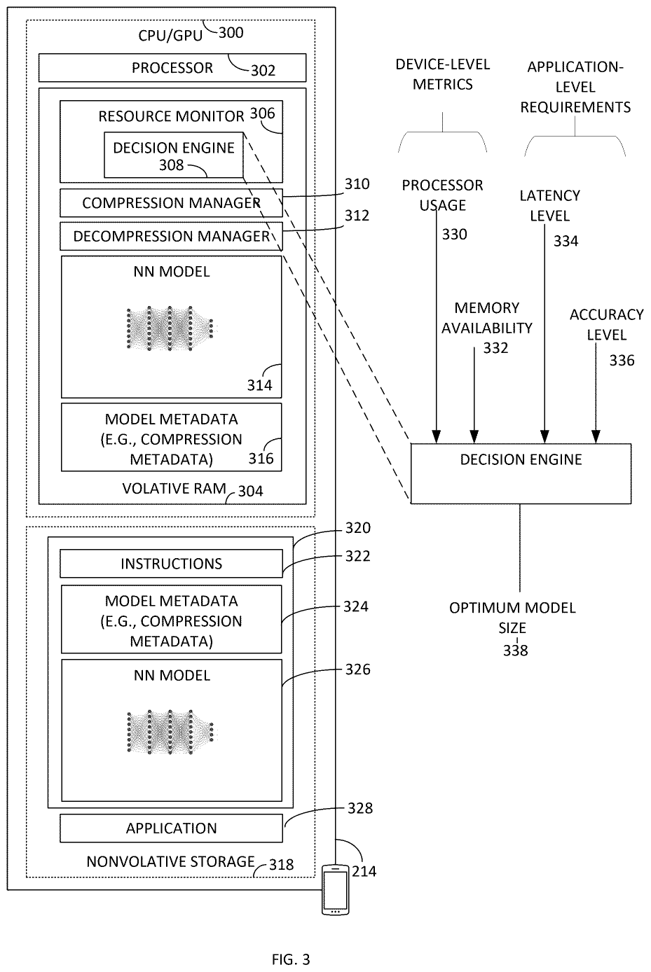

FIG. 3 illustrates a target device 214 architecture that implements dynamic neural network compression techniques, consistent with some embodiments of the present invention. At the hardware level, the device includes a CPU/GPU component 300 that comprises at least a processor 302 and volatile RAM 304. The volatile RAM 304 hosts several critical runtime components that enable dynamic compression and decompression of the neural network model.

The resource monitor 306 continuously tracks system device metrics and application requirements. It contains a decision engine 308 that analyzes monitored data to determine when compression is needed and what compression operations to perform. The compression manager 310 and decompression manager 312 execute the actual compression and restoration operations according to model-specific instructions.

The resource monitor 306 implements a comprehensive real-time monitoring system that tracks multiple resource metrics simultaneously. This includes profiling memory usage through RAM availability measurements, cache utilization patterns, and memory bandwidth consumption. The system maintains detailed metrics about how efficiently the cache is being used during model execution and monitors memory bandwidth to ensure optimal data transfer rates between storage and processing components.

For processing resources, the resource monitor continuously tracks CPU/GPU usage while monitoring thermal states and temperature thresholds. The monitoring system implements profiling of processor utilization patterns, enabling detection of both immediate spikes in processing demands and longer-term usage trends. This thermal monitoring is particularly critical as it can trigger immediate compression actions to prevent performance degradation or system instability.

The framework maintains awareness of I/O bandwidth availability and power conditions, including battery levels, charging status, and power consumption rates. For power management, the system tracks not only current battery status but also power consumption patterns to predict future resource availability. The I/O bandwidth monitoring enables the system to optimize data transfer operations between volatile RAM 304 and nonvolatile storage 318.

A key innovation of the resource monitor 306 is its management of resource allocation quotas for concurrent applications. The system tracks memory and processing requirements for all active applications, maintaining priority levels and resource quotas to ensure fair allocation. When multiple applications require access to the neural network model 314, the resource monitor 306 coordinates with the decision engine 308 to determine appropriate compression levels that satisfy both system constraints and application requirements.

The monitoring data flows into the decision engine 308, which implements a weighted decision system where immediate device constraints (like thermal limits) are weighted more heavily than gradual application requirement changes. This enables rapid response to critical resource constraints while maintaining stable performance for ongoing operations. The decision engine 308 coordinates with the compression manager 310 and decompression manager 312 to execute appropriate compression or restoration operations based on the monitored metrics.

The neural network model 314 resides in volatile RAM 304 during execution, along with its associated model metadata 316 that contains information about the current compression state. This architecture enables rapid compression and decompression operations as all components operate within RAM 304.

The validation framework implements precise performance metrics for assessing compression impact. Accuracy degradation is measured using both top-1 and top-5 accuracy on a validation dataset, with maximum allowable degradation of 20% and 10% respectively. Latency requirements are validated through averaged inference time measurements across 1000 consecutive operations, with a standard deviation threshold of 10 ms. Resource utilization targets are tracked through periodic sampling at 100 ms intervals, maintaining rolling averages over 5-minute windows to identify sustained deviations from target levels.

The device's nonvolatile storage 318 contains the runtime package 320 that includes three essential components: the compression/decompression instructions 322 that specify parameters for each operation, the model metadata 324 containing information needed for restoration, and the neural network model itself 326. This separation between volatile and nonvolatile storage enables persistent storage of compression information while maintaining quick access to actively used components.

During operation, the resource monitor's decision engine 308 analyzes system metrics to determine when compression is needed. When triggered, the compression manager 310 executes compression operations according to the stored instructions, while maintaining metadata that enables subsequent decompression. The decompression manager 312 can restore compressed components when resources become available, using the preserved metadata to reconstruct the original model characteristics.

The device 214 implements an innovative delta storage mechanism that preserves the difference between original and quantized weights during normal operation. The neural network model 314 runs efficiently with lower precision (INT8/FP16), benefiting from reduced memory bandwidth usage, simpler arithmetic operations, and lower power consumption. When higher precision is needed, the device 214 loads stored deltas only for critical calculations, temporarily restores precision for specific operations, and then returns to low-precision inference.

The delta storage implementation utilizes multiple compression techniques to efficiently store weight differences. The device 214 employs run-length encoding to compress sequences of similar delta values, Huffman coding to optimize the representation of frequently occurring deltas, and delta encoding between adjacent weights to minimize storage requirements. This multi-layered compression approach enables efficient storage of precision differences while maintaining rapid access for restoration.

Within the target device architecture shown in FIG. 3, the delta storage system operates across both volatile RAM 304 and nonvolatile storage 318. Recent and critical deltas are maintained in fast storage for immediate access, while less critical deltas are stored in slower storage using a sliding window approach for management. The system implements an index structure for quick retrieval of both weights and deltas, with version control for managing different precision states.

The compression manager 310 coordinates the delta storage process during compression operations. For each weight tensor, it calculates precision deltas (e.g., fp32_to_fp16_delta=original_fp32−fp16_value), compresses these deltas using the multi-layered compression techniques, and stores them with priority metadata. Critical path deltas are stored in fast-access storage tiers, while others are maintained in standard storage tiers. This tiered approach optimizes both storage efficiency and restoration speed.

Consistent with some embodiments, the device implements a checkpoint mechanism that saves compression states periodically, including both weight values and precision deltas. It backs up changes incrementally and manages recovery points for both compression methods while maintaining delta consistency. The error handling system provides paths for graceful degradation, handles resource exhaustion across both storage systems, and manages recovery from performance threshold violations.

Consistent with some embodiments, the device employs a predictive optimization framework that continuously evaluates and adjusts compression strategies based on historical performance data and anticipated resource needs. The framework maintains detailed performance histories for each model component, tracking accuracy metrics, resource utilization patterns, and compression effectiveness over time. This historical data enables the system to anticipate resource requirements and proactively adjust compression levels to minimize disruption to ongoing operations.

For performance history maintenance, the device 214 implements a tracking mechanism that monitors multiple metrics including inference latency, accuracy thresholds, and resource utilization across different compression states. The framework maintains separate histories for each compression technique (quantization, fusion, pruning), enabling fine-grained optimization of compression decisions based on observed performance patterns.

The device 214 implements proactive compression level adjustments based on predicted resource needs. Rather than waiting for resource constraints to become critical, the framework analyzes usage patterns and performance histories to anticipate when compression will be needed. This predictive approach, combined with the hybrid compression strategy, enables more efficient resource utilization than traditional fixed-strategy approaches.

Access pattern optimization is achieved through intelligent caching and data management. The runtime manager orchestrates memory pools for both direct weight access and delta restoration, optimizing caching based on observed access patterns. The device 214 implements transition rules based on resource thresholds and uses hysteresis mechanisms to prevent rapid oscillation between compression states.

Version control for precision states is managed through a persistent storage system that handles efficient encoding of compressed weights and precision deltas, maintaining separate storage hierarchies for each. The framework implements an index structure for quick retrieval of both weights and deltas, with version control mechanisms for managing different precision states. This enables the device to maintain consistency across compression operations while supporting rapid transitions between different precision levels.

The predictive optimization framework coordinates with the resource monitor 306 and decision engine 308 to ensure that compression decisions account for both immediate resource constraints and longer-term performance requirements. When the framework predicts that higher precision will be needed for upcoming operations, it initiates background restoration of critical weights while maintaining sufficient resources for current tasks.

A robust checkpoint system saves states periodically during compression operations, including both weight values and precision deltas. The device implements incremental backups that track changes to both compression states and metadata, enabling efficient storage while maintaining recoverability. Each checkpoint contains complete state information including compression levels, active operations, and restoration data necessary for recovery.

The error handling system provides multiple paths for graceful degradation when issues are encountered. When resource exhaustion occurs, the system can selectively decompress less critical components while maintaining essential model functionality. The fault tolerance framework includes state management capabilities that track the progress of compression operations across all compression layers, enabling the system to resume interrupted operations from the last stable checkpoint.

Recovery point management is implemented for both compression and decompression operations. The device maintains consistent checkpoints during each restoration phase, enabling rollback to stable configurations if errors occur. The validation system performs both structural and numerical verification of restored components, ensuring that weights are properly reintegrated and that the network maintains its expected performance characteristics. This includes gradient checks for restored connections and statistical validation of restored weight distributions.

Although not shown in FIG. 3, with some embodiments, a fault tolerance system coordinates with the resource monitor 306 and compression manager 310 to maintain system stability during compression operations. When potential issues are detected, the system can proactively adjust compression levels or initiate restoration of critical components before failures occur. The validation process includes both local and global consistency checks, ensuring that restored components maintain proper mathematical relationships with their neighboring network elements.

Error handling mechanisms include specific procedures for common failure scenarios. When compression operations fail mid-execution, the system maintains partial completion markers and implements exponential backoff retry logic, with initial retry delays of 100 ms doubling up to a maximum of 5 seconds. For state corruption scenarios, the system maintains cyclic redundancy checks (CRC) of weight values before and after compression operations, enabling rapid detection of data integrity issues.

Recovery procedures implement a multi-stage restoration process. The system maintains three distinct restoration points: a primary snapshot stored in RAM for immediate recovery, a secondary snapshot in flash storage for persistent recovery, and a baseline snapshot preserved in long-term storage. Recovery time objectives (RTO) are enforced through timeout mechanisms: immediate recovery must complete within 100 ms, while full restoration from persistent storage must complete within 1 second. These recovery mechanisms ensure system stability while maintaining application performance requirements.

State management and consistency is maintained through tracking mechanisms. The system implements transition rules based on resource thresholds and uses hysteresis mechanisms to prevent rapid oscillation between states. The weight restoration component maintains a priority queue for block restoration, uses predictive loading based on historical patterns, and performs restoration in the background to minimize disruption to inference operations.

Consistent with some embodiments, a dynamic scheduler operates as a component within the target device architecture shown in FIG. 3, coordinating compression and restoration operations through several key mechanisms. The scheduler maintains a priority queue for managing restoration operations, ranking components based on their potential performance impact. This queue considers multiple factors including the component's position in the network, its connectivity degree, and historical activation patterns to determine restoration order.

The device implements background loading mechanisms that preprocess restoration data for high-priority components while the network continues to operate. This predictive loading approach minimizes disruption to ongoing inference operations by preparing restoration data before it's needed. The scheduler coordinates with the compression manager 310 and decompression manager 312 to execute these background operations efficiently.

Historical pattern analysis enables predictive loading of model components. The scheduler tracks patterns of model usage and resource availability over time, using this information to anticipate when specific components are likely to be needed. For example, if certain model components are frequently restored during specific operations, the scheduler proactively begins loading those components when similar operations are detected.

To prevent rapid oscillation between compression states, the scheduler implements hysteresis mechanisms. These mechanisms establish thresholds for both compression and decompression operations, ensuring that the system maintains stable performance by avoiding frequent state changes. The scheduler coordinates with the resource monitor 306 to track system metrics and determine when these thresholds have been sustainably crossed before initiating state transitions.

The scheduler manages computational resources during restoration operations by monitoring processor utilization and memory allocation patterns. It adjusts the restoration rate based on current system load, battery status, and thermal conditions. Performance metrics are maintained throughout the restoration process, including inference latency and accuracy measurements, which the scheduler uses to adjust restoration speed and prioritization.

This architecture enables dynamic adaptation to changing device conditions while preserving the ability to restore the model's full capabilities when resources permit. The separation between volatile and nonvolatile components, combined with the coordinated operation of the monitoring and management systems, allows for efficient compression and decompression without requiring full model reloads.

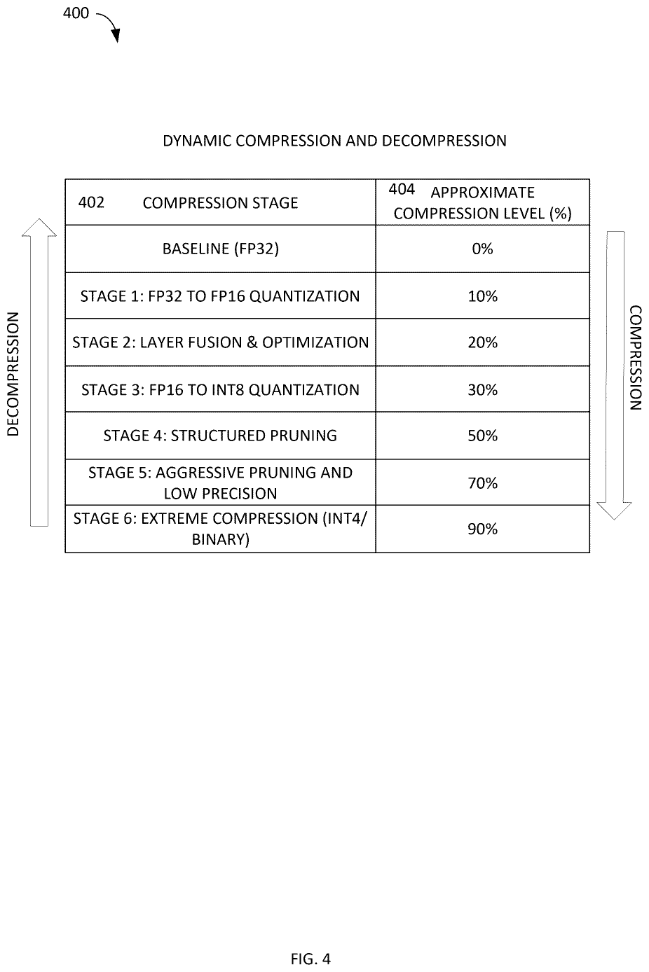

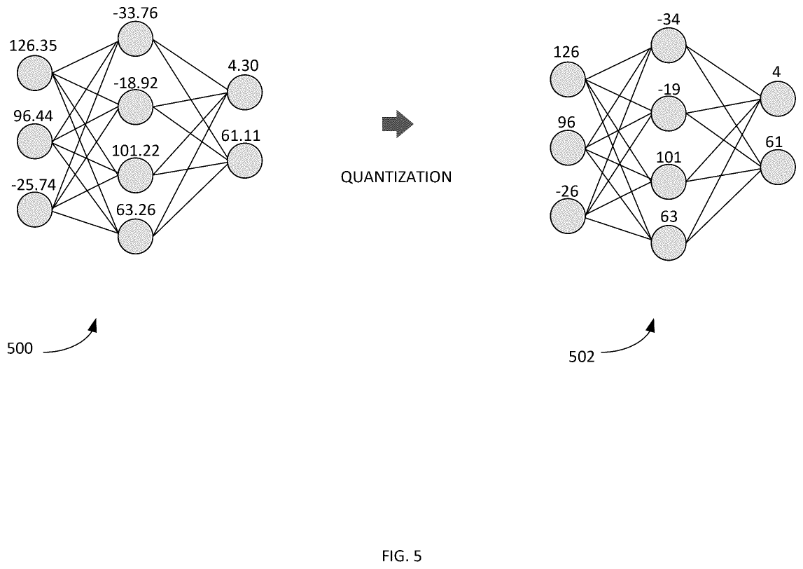

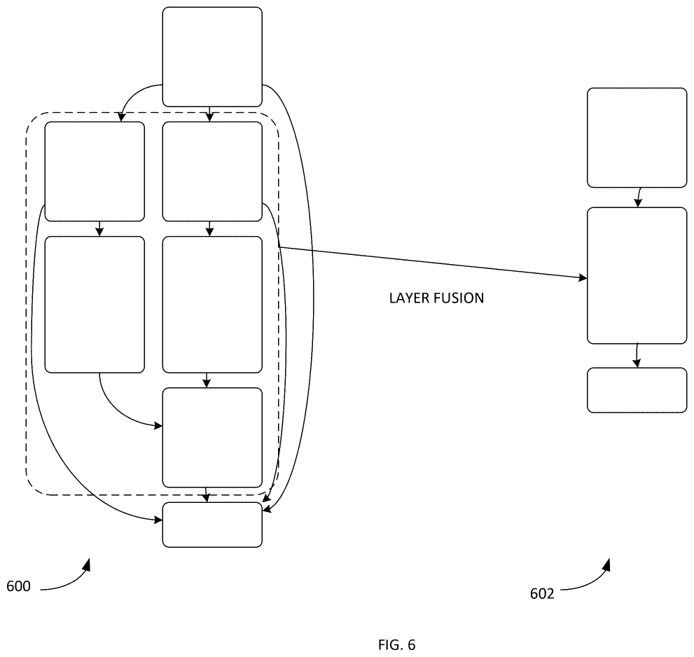

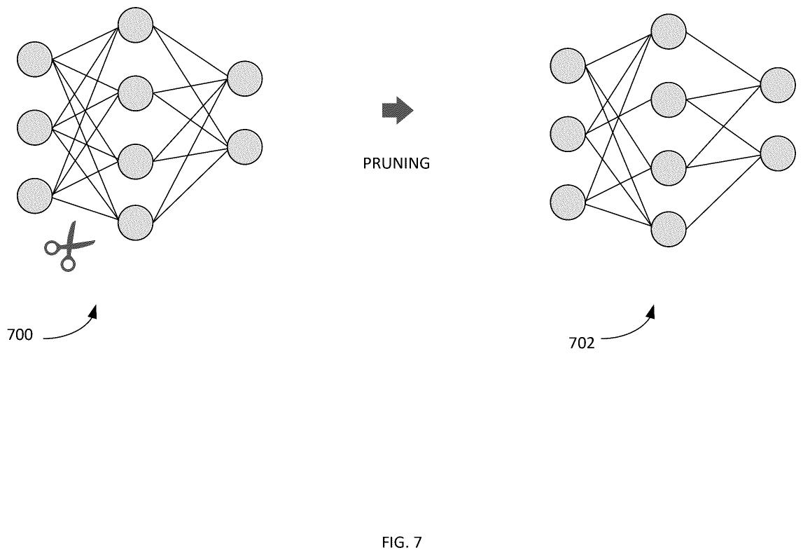

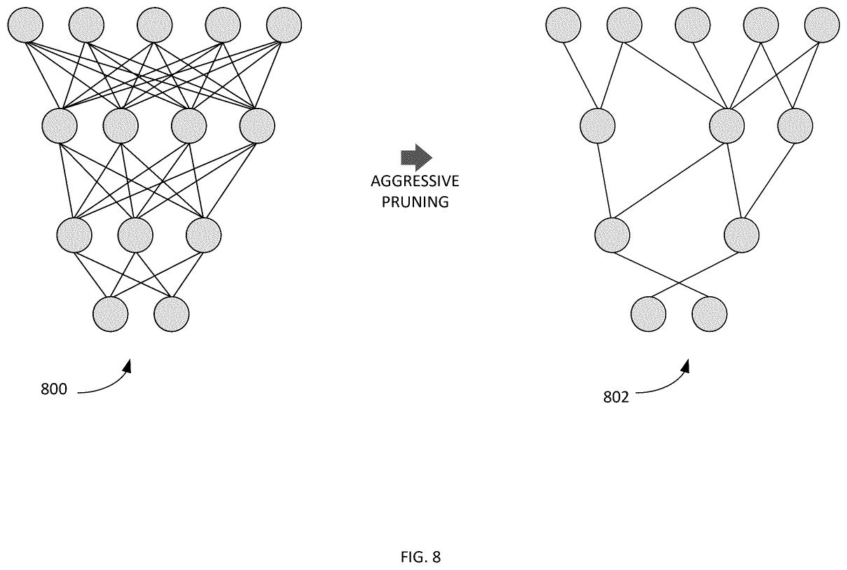

FIG. 4 is a table 400 illustrating progressive compression stages with corresponding compression levels achieved through sequential application of compression operations, consistent with some embodiments. The table 400 shows the dynamic compression and decompression stages 402 with their approximate compression levels 404, where each stage is further illustrated in subsequent figures-quantization operations are shown in FIG. 5, layer fusion is demonstrated in FIG. 6, structured pruning is depicted in FIG. 7, and aggressive pruning is illustrated in FIG. 8. The following detailed description explains how each compression stage operates and preserves the necessary metadata for potential restoration.

The baseline stage represents the uncompressed model using 32-bit floating point (FP32) precision with 0% compression. As illustrated in FIG. 5, which shows the before 500 and after 502 states of quantization compression, the first compression stage converts weights from FP32 to FP16 precision, achieving approximately 10% compression. During this conversion, the system calculates a scaling factor based on the maximum and minimum weight values for each layer, applies the scaling to convert the weights to lower precision, and stores the precise numerical differences (deltas) between the original FP32 values and the quantized FP16 values as compression metadata in long-term storage. For example, in FIG. 5, a weight value of 126.35 is converted to 126, with the delta of 0.35 preserved in metadata. This delta storage mechanism enables rapid restoration of the original precision when needed, as the system can simply load the stored deltas and add them back to the quantized weights without requiring complex recalculations.

The second stage, shown in FIG. 6, implements layer fusion and optimization, combining compatible consecutive layers like convolution and batch normalization operations to achieve approximately 20% compression. As illustrated in the before 600 and after 602 states of layer fusion, the system combines multiple sequential operations into a single optimized computation, significantly reducing memory and computational overhead. Layer fusion reduces memory requirements by merging operations that are frequently executed together, such as combining convolution weights with batch normalization parameters. The fusion process preserves mathematical equivalence through stored transformation coefficients (γ, β, μ, σ²) that enable precise reconstruction of the original separate layers when needed. For example, when fusing convolution and batch normalization layers, the system computes fused weights using the formula W_fused=γ*W_original, where γ represents the batch normalization scale factor, while maintaining the original parameters in metadata storage for potential restoration. The before state shows multiple separate operations with individual memory allocations, while the after state demonstrates the consolidated operation structure that maintains mathematical equivalence while reducing memory footprint.

The third stage, also illustrated in FIG. 5, further reduces precision by converting FP16 weights to INT8 format through quantization, reaching approximately 30% compression. During this conversion, the system calculates a scaling factor based on the maximum and minimum values in each layer (e.g., 255/max(w)) to optimize the INT8 range. As shown in the before 500 and after 502 states of the quantization process, weight values are reduced to lower precision while maintaining network connectivity-for example, a weight value of 126.35 is converted to 126, with the system preserving the precise numerical differences between FP16 and INT8 values as delta values in compression metadata, enabling exact restoration when needed. For example, if an INT8 weight value is 120 with scale factor 0.1, the system stores the delta needed to restore the original higher precision value (12.0).

The fourth stage employs structured pruning, as demonstrated in FIG. 7, where less important neural connections are selectively removed while maintaining critical pathways, achieving approximately 50% compression. The system calculates importance scores for weights in each layer based on their activation patterns and gradient magnitudes, removing weights with scores below thresholds specified in the pruning parameters. As illustrated in the before pruning 700 and after pruning 702 states, the network structure is simplified by removing less important connections while preserving the essential pathways that maintain model functionality. For each pruned weight, the system stores both a pruning mask identifying its location and its original value in the compression metadata, enabling precise reconstruction of the original network connectivity when resources permit restoration.

The fifth stage implements aggressive pruning, shown in FIG. 8, which eliminates entire filters, channels, or layers to achieve approximately 70% compression while preserving essential network functionality. The system identifies components for removal based on their computational impact while ensuring critical pathways remain intact. For each eliminated component, the system stores comprehensive configuration data including filter parameters, channel mappings, and associated weight values as compression metadata. This preservation enables the system to reconstruct the full network architecture during decompression, restoring eliminated components in order of their importance when resources become available.

The final stage represents extreme compression through conversion to 4-bit or binary precision, achieving up to 90% compression for scenarios with severe resource constraints. During this conversion, the system scales the original weight values to fit within the extremely limited range of 4-bit integers (−8 to 7) or binary values (0 or 1), while preserving the precise numerical relationships through stored scaling factors and delta values in the compression metadata. For example, an original weight value of 0.8 might be converted to an INT4 value of 7 using appropriate scaling, with the system storing both the scaling factor and the numerical difference needed to restore the original value. This extreme compression stage is typically only activated under severe resource constraints, and the preserved metadata enables rapid restoration to higher precision when resources become available.

Each stage preserves the necessary metadata for potential restoration, enabling dynamic decompression when resources become available. During the training phase, the system analyzes the neural network model to generate model-specific compression instructions. These instructions specify parameters for each compression operation and layer, enabling rapid compression during runtime without requiring complex calculations.

For quantization operations, the system calculates scaling factors based on the maximum and minimum weight values in each layer. When converting from higher to lower precision (e.g., FP32 to FP16), the system stores the precise numerical differences as delta values in compression metadata. For example, when quantizing from FP16 to INT8, a weight value of 0.1235 might be converted to 32 using a scale factor of 255/max(w), with the delta preserved for potential restoration.

Layer fusion combines compatible consecutive operations while maintaining mathematical equivalence. For instance, when fusing convolution and batch normalization layers, the system computes fused weights using the formula W_fused=γ*W_original, where γ represents the batch normalization scale factor. The original layer parameters, including BatchNorm scale (γ), mean (μ), variance (σ²), and bias (β), are preserved in metadata storage.

For structured pruning, the system calculates importance scores for weights based on their activation patterns and gradient magnitudes. Weights with scores below specified thresholds are removed, with their locations recorded in pruning masks and their values preserved in compression metadata. This enables precise reconstruction of the original network connectivity when resources permit.

Aggressive pruning eliminates entire filters, channels, or layers while maintaining critical pathways. The system stores comprehensive configuration data including filter parameters, channel mappings, and associated weight values. This preservation enables reconstruction of the full network architecture during decompression, with components restored in order of their importance.

The compression metadata is organized in a tiered storage system, with frequently accessed information kept in faster storage while less critical data resides in slower storage. This organization enables rapid access to restoration data while managing storage efficiently. The metadata includes scaling factors, transformation coefficients, pruning masks, and configuration data needed to reverse each compression operation.

During runtime, the resource monitor 306 actively tracks multiple system metrics and application requirements through continuous monitoring. For device-level metrics, it profiles memory usage through RAM availability measurements, cache utilization patterns, and memory bandwidth consumption; monitors CPU/GPU usage while tracking thermal states and temperature thresholds; maintains awareness of power conditions including battery levels, charging status, and power consumption rates; and tracks I/O bandwidth availability. For application-level requirements, the monitor tracks accuracy thresholds for model outputs, measures inference latency, monitors application priority levels, and manages resource allocation quotas for concurrent applications. The decision engine 308 analyzes these metrics to determine when compression or decompression operations should be performed, with immediate device constraints like thermal limits weighted more heavily than gradual application requirement changes. The compression manager 310 then executes these operations according to the model-specific instructions while maintaining all necessary metadata in both volatile RAM and nonvolatile storage for potential restoration.

The compression stages and levels shown in FIG. 4 represent one example implementation for a specific neural network model and target device configuration. Consistent with some embodiments, the sequence of compression operations may be reordered based on model-specific characteristics and device constraints, and the actual compression levels achieved at each stage may vary significantly depending on the model architecture, training data, and target device specifications. For example, some models may achieve greater compression through quantization while others may benefit more from layer fusion or pruning operations, and the instruction file accompanying each model specifies the optimal sequence and parameters for that particular model-device combination.

The system implements multi-service support capabilities within the target device architecture shown in FIG. 3. The resource monitor 306 tracks memory and processing requirements across multiple concurrent services, maintaining individual accuracy thresholds and performance targets for each service. When multiple applications require access to the neural network model 314, the system dynamically adjusts compression levels to meet service-specific requirements while optimizing overall resource utilization.

Memory allocation management is handled through a quota-based system that considers both immediate and anticipated resource needs of concurrent services. The decision engine 308 implements priority-based allocation, ensuring critical services maintain necessary model capabilities while less critical services operate with higher compression levels. This enables efficient sharing of model resources across multiple applications with varying performance requirements.

Service-specific accuracy requirements are maintained through selective compression and restoration of model components. The system tracks accuracy metrics for each service independently, enabling fine-grained control over which parts of the model are compressed or restored based on individual service needs. When services compete for resources, the system uses priority levels and performance impact scores to optimize compression decisions.

The advantages of this approach over conventional systems are significant. First, unlike traditional fixed compression approaches that permanently discard model components, this system maintains full restoration capability through preserved metadata, enabling dynamic adaptation to changing service requirements without model reloads.

Second, the ability of the system to simultaneously optimize for both device constraints and application requirements represents a significant advance over existing solutions that focus solely on device limitations. This dual-constraint approach enables more efficient resource utilization while maintaining service-specific performance targets.

Finally, the sophisticated priority management and background loading capabilities of the system enable smooth transitions between compression states without service interruption. This represents a substantial improvement over conventional systems that require complete model reloads or suffer from performance degradation during compression state changes.

### Machine and Software Architecture

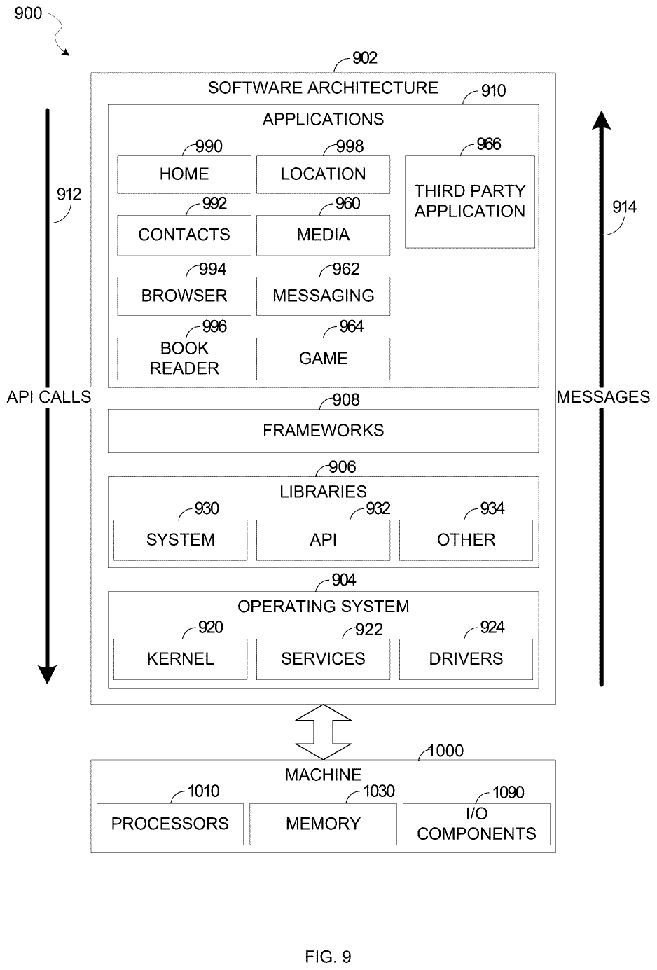

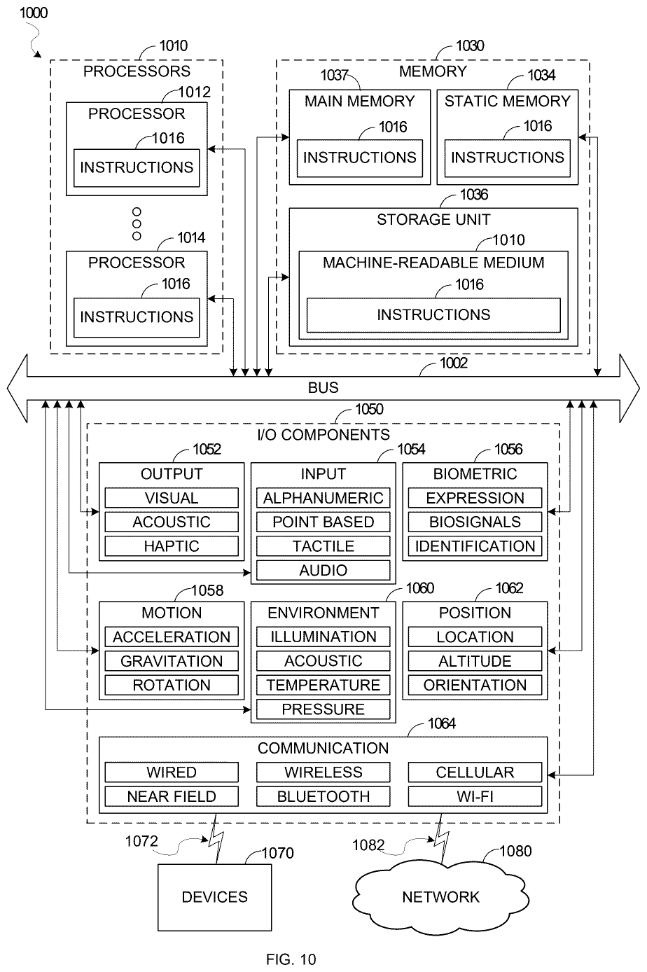

FIG. 9 is a block diagram 900 illustrating a software architecture 902, which can be installed on any of a variety of computing devices to perform methods consistent with those described herein. FIG. 9 is merely a non-limiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example architecture, the software architecture 902 can be conceptualized as a stack of layers where each layer may provide a particular functionality. For example, the software architecture 902 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various GUI functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

FIG. 10 illustrates a diagrammatic representation of a machine 1000 in the form of a computer system within which a set of instructions may be executed for causing the machine to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions 1016 may cause the machine 1000 to execute any one of the methods or algorithmic techniques described herein. Additionally, or alternatively, the instructions 1016 may implement any one of the systems described herein. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 6 shows multiple processors 1010, the machine 1000 may include a single processor with a single core, a single processor with multiple cores (e.g., a multi-core processor), multiple processors with a single core, multiple processors with multiples cores, or any combination thereof.

The memory 1030 may include a main memory 1032, a static memory 1034, and a storage unit 1036, all accessible to the processors 1010 such as via the bus 1002. The main memory 1030, the static memory 1034, and storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 6. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1030, 1032, 1034, and/or memory of the processor(s) 1010) and/or storage unit 1036 may store one or more sets of instructions and data structures (e.g., software) embodying or utilized by any one or more of the methodologies or functions described herein. These instructions (e.g., the instructions 1016), when executed by processor(s) 1010, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1080 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method for dynamically compressing a neural network model stored in memory of a computing device, the method comprising:
while monitoring computing resource metrics comprising at least one of a processor utilization metric and a memory utilization metric, and one or more application requirements, detecting a condition requiring compression of the neural network model:
determining a target compression level for the neural network model based on values of the one or more computing resource metrics, the one or more application requirements, or a combination thereof;
performing one or more compression operations in a sequence of compression operations according to model-specific compression instructions until the target compression level is achieved, wherein the model-specific compression instructions specify compression parameters for each layer of the neural network model and for each compression operation to be performed on that layer, the sequence of compression operations comprising two or more of:
quantizing weights of one or more layers of the neural network model by converting the weights from a higher precision format to a lower precision format according to quantization parameters specified in the model-specific compression instructions, while storing precision differences as compression metadata in storage for potential restoration;
combining compatible consecutive layers of the neural network model through layer fusion according to fusion parameters specified in the model-specific compression instructions while storing layer fusion metadata comprising original layer parameters and transformation coefficients in storage for potential restoration;
removing one or more weights in one or more layers of the neural network model through structured pruning according to pruning parameters specified in the model-specific compression instructions while storing pruning masks and associated weight values as compression metadata in storage for potential restoration; and
eliminating filters, channels, or layers of the neural network model, or some combination thereof, through aggressive pruning according to pruning parameters specified in the model-specific compression instructions while storing filter configurations, channel mappings, and associated weight values as compression metadata in storage for potential restoration; and
after performing the two or more compression operations, validating performance of the compressed neural network model by monitoring accuracy and latency metrics of the compressed neural network model.

2. The method of claim 1, wherein determining the target compression level comprises:
receiving a request for memory allocation from an application;
determining an amount of memory required by the application; and
calculating the target compression level that will free sufficient memory to accommodate the memory requirement of the application.

3. The method of claim 1, wherein the quantizing compression operation comprises:
calculating a scaling factor based on maximum and minimum weight values for each layer;
converting weights to lower precision values using the scaling factor; and
storing precision differences between original and quantized weights as delta values in the compression metadata.

4. The method of claim 1, wherein the layer fusion compression operation comprises:
identifying consecutive layers eligible for fusion based on layer compatibility parameters;
combining eligible consecutive layers by merging their operations while maintaining mathematical equivalence;
calculating transformation coefficients for the merged operations; and
storing the original layer parameters and transformation coefficients in the compression metadata.

5. The method of claim 1, wherein the structured pruning compression operation comprises:
calculating importance scores for weights in each layer based on their activation patterns and gradient magnitudes;
removing weights having importance scores below a threshold value specified in the pruning parameters; and
storing pruning masks identifying removed weights and their associated values in the compression metadata.

6. The method of claim 1, wherein the aggressive pruning compression operation comprises:
identifying filters, channels, or layers eligible for removal based on their computational impact;
eliminating identified components while maintaining critical network pathways;
adjusting remaining network connections to preserve information flow; and
storing configuration data for eliminated components in the compression metadata.

7. The method of claim 1, wherein validating performance of the compressed neural network model comprises:
tracking accuracy and latency metrics of the compressed neural network model;
comparing the tracked metrics against predefined performance thresholds; and
when the tracked metrics fall below the predefined performance thresholds and sufficient system resources are available, selectively restoring one or more compressed components using the stored compression metadata.

8. A system for dynamically compressing a neural network model stored in at least one memory storage device, the system comprising:
at least one processor;
at least one memory storage device storing instructions thereon, which, when executed by the at least one processor cause the system to perform operations comprising:
while monitoring computing resource metrics comprising at least one of a processor utilization metric and a memory utilization metric, and one or more application requirements, detecting a condition requiring compression of the neural network model;
determining a target compression level for the neural network model based on values of the one or more computing resource metrics, the one or more application requirements, or a combination thereof;
performing one or more compression operations in a sequence of compression operations according to model-specific compression instructions until the target compression level is achieved, wherein the model-specific compression instructions specify compression parameters for each layer of the neural network model and for each compression operation to be performed on that layer, the sequence of compression operations comprising two or more of:
quantizing weights of one or more layers of the neural network model by converting the weights from a higher precision format to a lower precision format according to quantization parameters specified in the model-specific compression instructions, while storing precision differences as compression metadata in storage for potential restoration;
combining compatible consecutive layers of the neural network model through layer fusion according to fusion parameters specified in the model-specific compression instructions while storing layer fusion metadata comprising original layer parameters and transformation coefficients in storage for potential restoration;
removing one or more weights in one or more layers of the neural network model through structured pruning according to pruning parameters specified in the model-specific compression instructions while storing pruning masks and associated weight values as compression metadata in storage for potential restoration; and
eliminating filters, channels, or layers of the neural network model, or some combination thereof, through aggressive pruning according to pruning parameters specified in the model-specific compression instructions while storing filter configurations, channel mappings, and associated weight values as compression metadata in storage for potential restoration; and
after performing the two or more compression operations, validating performance of the compressed neural network model by monitoring accuracy and latency metrics of the compressed neural network model.

9. The system of claim 8, wherein determining the target compression level comprises:
receiving a request for memory allocation from an application;
determining an amount of memory required by the application; and
calculating the target compression level that will free sufficient memory to accommodate the memory requirement of the application.

10. The system of claim 8, wherein the quantizing compression operation comprises:
calculating a scaling factor based on maximum and minimum weight values for each layer;
converting weights to lower precision values using the scaling factor; and
storing precision differences between original and quantized weights as delta values in the compression metadata.

11. The system of claim 8, wherein the layer fusion compression operation comprises:
identifying consecutive layers eligible for fusion based on layer compatibility parameters;
combining eligible consecutive layers by merging their operations while maintaining mathematical equivalence;
calculating transformation coefficients for the merged operations; and
storing the original layer parameters and transformation coefficients in the compression metadata.

12. The system of claim 8, wherein the structured pruning compression operation comprises:
calculating importance scores for weights in each layer based on their activation patterns and gradient magnitudes;
removing weights having importance scores below a threshold value specified in the pruning parameters; and
storing pruning masks identifying removed weights and their associated values in the compression metadata.

13. The system of claim 8, wherein the aggressive pruning compression operation comprises:
identifying filters, channels, or layers eligible for removal based on their computational impact;
eliminating identified components while maintaining critical network pathways;
adjusting remaining network connections to preserve information flow; and
storing configuration data for eliminated components in the compression metadata.

14. The system of claim 8, wherein validating performance of the compressed neural network model comprises:
tracking accuracy and latency metrics of the compressed neural network model;
comparing the tracked metrics against predefined performance thresholds; and
when the tracked metrics fall below the predefined performance thresholds and sufficient system resources are available, selectively restoring one or more compressed components using the stored compression metadata.

15. A machine-readable storage medium storing instructions thereon, which, when executed by at least one processor of a device, cause the device to perform operations comprising:
while monitoring computing resource metrics comprising at least one of a processor utilization metric and a memory utilization metric, and one or more application requirements, detecting a condition requiring compression of the neural network model;
determining a target compression level for the neural network model based on values of the one or more computing resource metrics, the one or more application requirements, or a combination thereof;
performing one or more compression operations in a sequence of compression operations according to model-specific compression instructions until the target compression level is achieved, wherein the model-specific compression instructions specify compression parameters for each layer of the neural network model and for each compression operation to be performed on that layer, the sequence of compression operations comprising two or more of:
quantizing weights of one or more layers of the neural network model by converting the weights from a higher precision format to a lower precision format according to quantization parameters specified in the model-specific compression instructions, while storing precision differences as compression metadata in storage for potential restoration;
combining compatible consecutive layers of the neural network model through layer fusion according to fusion parameters specified in the model-specific compression instructions while storing layer fusion metadata comprising original layer parameters and transformation coefficients in storage for potential restoration;
removing one or more weights in one or more layers of the neural network model through structured pruning according to pruning parameters specified in the model-specific compression instructions while storing pruning masks and associated weight values as compression metadata in storage for potential restoration; and
eliminating filters, channels, or layers of the neural network model, or some combination thereof, through aggressive pruning according to pruning parameters specified in the model-specific compression instructions while storing filter configurations, channel mappings, and associated weight values as compression metadata in storage for potential restoration; and
after performing the two or more compression operations, validating performance of the compressed neural network model by monitoring accuracy and latency metrics of the compressed neural network model.

16. The machine-readable medium of claim 15, wherein determining the target compression level comprises:
receiving a request for memory allocation from an application;
determining an amount of memory required by the application; and
calculating the target compression level that will free sufficient memory to accommodate the memory requirement of the application.

17. The machine-readable medium of claim 15, wherein the quantizing compression operation comprises:
calculating a scaling factor based on maximum and minimum weight values for each layer;
converting weights to lower precision values using the scaling factor; and
storing precision differences between original and quantized weights as delta values in the compression metadata.

18. The machine-readable medium of claim 15, wherein the layer fusion compression operation comprises:
identifying consecutive layers eligible for fusion based on layer compatibility parameters;
combining eligible consecutive layers by merging their operations while maintaining mathematical equivalence;
calculating transformation coefficients for the merged operations; and
storing the original layer parameters and transformation coefficients in the compression metadata.

19. The machine-readable medium of claim 15, wherein the structured pruning compression operation comprises:
calculating importance scores for weights in each layer based on their activation patterns and gradient magnitudes;
removing weights having importance scores below a threshold value specified in the pruning parameters; and
storing pruning masks identifying removed weights and their associated values in the compression metadata.

20. The machine-readable medium of claim 15, wherein the aggressive pruning compression operation comprises:
identifying filters, channels, or layers eligible for removal based on their computational impact;
eliminating identified components while maintaining critical network pathways;
adjusting remaining network connections to preserve information flow; and
storing configuration data for eliminated components in the compression metadata.
